(19) United States
(12) Patent Application Publication
(10) Pub. No.: US 2026/0135284 A1
(43) Pub. Date: May 14, 2026

(54) RADOME AND METHOD OF HEATING A SURFACE OF A RADOME

(71) Applicant: Solace Power Inc., Mount Pearl (CA)

(72) Inventors: Ahmad ALMUDALLAL, St. John's (CA); Thomas SEARY, Mount Pearl (CA); Noah HANSEN, St. John's (CA)

(73) Assignee: Solace Power Inc., Mount Pearl (CA)

(21) Appl. No.: 19/381,592

(22) Filed: Nov. 6, 2025

Related U.S. Application Data
(60) Provisional application No. 63/718,299, filed on Nov. 8, 2024.
(60) Provisional application No. 63/725,009, filed on Nov. 26, 2024.

(51) Int. Cl. H01Q 1/02; H01F 27/28; H01Q 1/42; H02J 50/10

(52) U.S. Cl. CPC H01Q 1/02; H01F 27/28; H01Q 1/42; H02J 50/10

(57) ABSTRACT

A radome is provided. The radome comprises a heating element positioned on a surface of the radome, the heating element consisting of a receiver coil of a receiver of a wireless power transfer system, the receiver coil formed of a resistive foil material; and a transmitter coil of a transmitter of a wireless power transfer system, the transmitter coil for generating a magnetic field for transferring power to the receiver coil via magnetic field coupling.

### CROSS-REFERENCE TO RELATED APPLICATIONS

This application claims the benefit of U.S. Provisional Application No. 63/718,299 filed Nov. 8, 2024 and U.S. Provisional Application No. 63/725,009 filed Nov. 26, 2024, the entire contents of each of which are hereby incorporated by reference.

### FIELD

The subject disclosure generally relates to radomes, and in particular to a radome and heating a surface of a radome via wireless power.

### BACKGROUND

Wireless power transfer systems such as wireless charging are becoming an increasingly important technology to enable the next generation of devices. The potential benefits and advantages offered by the technology is evident by the increasing number of manufacturers and companies investing in the technology.

A variety of wireless power transfer systems are known. A typical wireless power transfer system includes a power source electrically connected to a wireless power transmitter, and a wireless power receiver electrically connected to a load.

In magnetic induction systems, the transmitter has a transmitter coil with a certain inductance that transfers electrical energy from the power source to the receiver, which has a receiver coil with a certain inductance. Power transfer occurs due to coupling of magnetic fields between the coils or inductors of the transmitter and receiver. Such induction system may non-resonant or resonant. In resonant magnetic induction the inductors are resonated using capacitors. The range of power transfer in resonant magnetic systems may be increased over that of magnetic induction systems and alignment issues may be rectified.

In electrical induction systems, the transmitter and receiver have capacitive electrodes. Power transfer occurs due to coupling of electric fields between the capacitive electrodes of the transmitter and receiver. Similar, to resonant magnetic systems, there exist resonant electric systems in which the capacitive electrodes of the transmitter and receiver are made resonant using inductors, e.g., coils. Resonant electric systems may have an increased range of power transfer compared to that of electric induction systems and alignment issues may be rectified.

While some wireless power transfer systems are known, improvements are desired. It is therefore an object to provide a cooling arrangement for a wireless power transfer system, wireless power transfer system and/or method of cooling a receiver.

This background serves only to set a scene to allow a person skilled in the art to better appreciate the following description. Therefore, none of the above discussion should necessarily be taken as an acknowledgement that the discussion is part of the state of the art or is common general knowledge. One or more aspects/embodiments of the invention may or may not address one or more of the background issues.

### SUMMARY

According to an aspect there is provided a radome including a wireless power transfer system and a sensor enclosed by a transmitter coil. The wireless transfer system includes: a transmitter comprising the transmitter coil for generating a magnetic field; and a receiver comprising a receiver coil for extracting power from the generated field for heating a surface of the radome.

According to another aspect there is provided a radome including: a heating element for heating a surface of the radome, the heating element consisting of a receiver coil of a receiver of a wireless power transfer system; and a transmitter coil of a transmitter of a wireless power transfer system, the transmitter coil for generating a magnetic field for transferring power to the receiver coil via magnetic field coupling.

The receiver coil may be positioned on the surface of the radome, or may be embedded within the radome. As such, the transmitter coil may transfer power via magnetic field coupling through the surface of the radome to the receiver coil. The transmitter coil may transfer power to the receiver coil through another medium proximate the surface such as air or liquid. The transferred power may heat the receiver coil which may heat the surface of the radome. The receiver coil may be positioned on the surface of the radome such that the radome is between the receiver coil and the transmitter coil, or such that only a medium is between the transmitter and receiver coils, such as air or water. The material of the surface of the radome may be selected such that the generated magnetic field may pass through the radome to transfer power to the receiver coil. The receiver coil may be positioned/located on an inner surface of the radome or an outer surface of the radome.

The receiver coil or loop extracts power from a field generated by the transmitter coil. The extracted power heats the receiver coil. The receiver coil heats the surface of the radome. While the receiver may be on a side of the surface which is protected from the environment, another side (e.g., the opposite side) of the surface may be exposed to the environment. As such snow, ice, rain, etc., may be present on the surface. Such elements may inhibit, obstruct or otherwise affect a sensor signal emitted by the sensor. Heating the surface may at least partially remove or melt these obstructions. This may improve the effectiveness of the sensor.

Furthermore, while the receiver could be powered via a wired connection with the transmitter coil, a wired connection may be difficult to reliability achieve in hard to reach enclosures, or may inhibit sensor functionality. For example, in the case of a rotating antenna in a dome, a wired connection to the receiver coil may not allow for the full range of motion of the antenna. This may negatively impact the effectiveness of the sensor (antenna). Additionally, a wired connection may require expensive, large and costly to maintain electrical connection elements, e.g., a cable or wiring harnesses. Such electrical connection elements may take up considerable space which may increase the size of the radome. This may limit use of the radome (sensor) to only applications where the necessary space is not available. This may thus limit applications of the radome.

The described radome may at least partially address one or more of these issues.

For the purposes of the subject disclosure, a radome is defined as a surface overlaying a sensor, e.g., antenna, radar detector, Lidar detector, etc. While a radome typically takes the form a radar dome, hence the name (a combination of the words radar and dome), the described sensor may be something other than radar. Similarly the surface may not be part of a dome. For example the surface may form part of another structure as will be set out below.

A radome may comprise or consist of a protective covering that is substantially radar transparent. The radome may be formed from plastics that are electrically insulating. The receiver element may heat the surface of the radome, in order to keep the radome surface free from ice and/or snow. In particular, the receiver element may heat the surface of the radome free from ice and/or snow during driving of a vehicle. This ensures the proper functionality of the radar associated with the radome as sensing and propagation of EM waves associated with the radar are propagated without being impacted by the ice and/or snow.

The surface of the radome may be protective as it may protect the sensor from the external environment. The surface may conceal the sensor from view. The surface may be normally transparent to a sensor signal emitted by the sensor, e.g., radio waves, in that the sensor signal may pass through the surface when there is nothing present on the surface, e.g., snow, ice, rain, water, etc. The surface may be part of a vehicle such as the front portion of a vehicle including a vehicle bumper, hood, tailgate, trunk, sidewall, body panel, etc. The surface may be curved, i.e., concave, convex, spherical, etc.

The surface may have high radar transparency for electromagnetic waves generated by a radar, e.g., radar for use in a vehicle. The surface may allow electromagnetic waves generated by a radar to pass through with little, or minimal attenuation.

The surface may be part of an enclosure which encloses the receiver coil, transmitter coil and/or sensor. As such the surface may be part of a housing, case or other body which protects the elements of the wireless power transfer system and sensor from the environment. In particular, elements of the wireless power transfer system, such as the receiver coil, have high radar transparency, meaning that the coil allows the radar signal to pass through with minimal attenuation.

The receiver coil may be proximate one side of a surface of the radome while the external environment is on the other side, i.e., opposite side, of the surface of the radome. The receiver coil may be protected by the surface from the external environment by the surface. The receiver coil may be in contact with the surface.

The receiver may comprise no other elements beyond the receiver coil. In other words, the receiver may only comprise or consist of the receiver coil. Thus, the receiver may not comprise a load, or the receiver coil may form the load of the receiver. The receiver coil may simply be heated by the extracted power from the field generated by the transmitter coil. The receiver may not a direct current/direct current (DC/DC) converter or rectifier which are typically present in wireless power transfer receivers.

The described radome may further comprises a detector, detection module or sensor positioned within the transmitter coil. The transmitter coil may circumscribe or enclose the sensor. The sensor may be positioned within the area or volume defined by the transmitter coil.

In another arrangement, the sensor is positioned within the receiver coil. The receiver coil may circumscribe or enclose the sensor. The sensor may be positioned within the area or volume defined by the receiver coil.

The receiver and transmitter coils may be concentric. The receiver and transmitter coils may be overlapping or may overlay one another. The receiver and transmitter coils may each independently form a plane. The planes of the coils may be parallel.

The receiver coil forms a closed loop. The transmitter coil may form a closed loop. The receiver and/or transmitter coil may have multiple windings or loops.

The receiver coil may comprise resistive wire. The receiver coil may be formed of resistive wire.

A resistance of the receiver coil may be optimised for a particular application, radome, or heating requirements. The resistance may be optimised by varying a wire diameter of the receiver coil. A heating efficiency of the receiver coil may be dependent on a resistance around the receiver coil. If the resistance is too high, a current at the receiver coil is reduce such that little heat is generated. If the resistance is too low, the current at the receiver coil flows, but dissipates little heat. For a given receiver coil, the resistance may be adjusted by selecting the diameter of the resistive wire. In other words varying the diameter of the resistive wire may optimise the heat transfer efficiency of the receiver coil for a particular receiver coil configuration or shape. The heat transfer efficiency may be defined as a ratio of the extracted power to the heat generated by the receiver coil. Optimising the resistance of the receiver coil may maximize the heat transfer efficiency of the radome.

The resistive wire may have a diameter of 0.1 mm. The resistive wire may have a diameter of 0.8 mm to 0.1 mm. The resistive wire may have a diameter of any one of 0.8 mm, 0.7 mm, 0.6 mm, 0.5 mm, 0.4 mm, 0.3 mm, 0.2 mm and 0.1 mm.

The resistive wire may comprise silver or nichrome wire, or similar resistive wire.

The receiver coil may comprise printed traces, i.e., printed traces of a printed circuit board (PCB).

The receiver coil may comprise a serpentine coil.

The receiver coil may comprise a loop. The loop may be a closed loop. The loop may be continuous. The loop may comprise one or more windings. In other words, multiple windings may form a single continuous loop following the same path. The receiver coil may be formed in a single plane. The plane formed by the receiver coil may be parallel to the plane formed by the transmitter coil. The receiver coil and transmitter coil may be parallel. The planes formed by both coils may be curved, e.g., convex or concave. The curved planes may be parallel.

The coils may be separated by a separation distance. The separation distance may be constant throughout the span of the coils.

The receiver coil may comprise one or more fingers. The fingers may form part of the loop. The fingers may be inner or outer fingers. The fingers may be inner or outer fingers with respect to the loop. The loop and fingers may form a closed loop. The loop and inner and outer fingers may form a single plane. The plane may be parallel with a plane formed by the transmitter coil. The fingers may extend from an outer loop towards a centre of the loop (i.e., inner fingers), or from an inner loop outwards away from a centre of the loop (i.e., outer fingers). All of the fingers may extend in a single direction. In other words, the fingers may be parallel. The fingers may extend in the same direction as the short dimension of the loop. The fingers may extend in the same direction as the long dimension of the loop.

A first plurality of the fingers may extend in a first direction and a second plurality of fingers may extend in a second direction. The first and second directions may be perpendicular. The fingers may have the same length extending away from the loop. The fingers may have varying length extending away from the loop. The fingers may be evenly spaced in the plane formed by the loop and fingers of the receiver coil. Each finger may have a finger width, i.e., a distance between the sides of the fingers. Each finger may have the same or different finger widths. Each finger may be formed by generally parallel wires of the receiver coil. The wires may be separated by the finger width of the finger.

The receiver coil may define a loop and fingers. The loop and fingers may define a plane in two axes. Each finger extend inwards or outwards from the loop in the plane towards a centre of the loop or away from the centre. Each finger has a corresponding bend away from or towards the centre of the loop. The bend has a minimum radius based on a minimum finger width of the finger. The fingers may have a teardrop shape in the bend between parallel sides of the finger.

The loop may be generally square, rectangular, circular, oval, trapezoidal or other shape.

The fingers may be evenly spaced in a plane formed by the loop. The space between fingers may be defined as the finger spacing. The fingers may have a finger spacing of 1 mm, 5 mm, 10 mm, 12 mm, 14 mm, 16 mm, 18 mm, and 20 mm. The

The finger spacing may be optimised to maximize efficiency of the radome. Efficiency may comprise the wireless power transfer efficiency and/or the heat transfer efficiency. The finger spacing may be optimised to evenly distribute heat across the surface of the radome.

The fingers may extend in a first direction within a plane formed by the loop.

The fingers extend in a second direction within the plane.

The first direction may be perpendicular to the second direction in the plane.

The fingers may extend in multiple directions from the loop of the receiver coil. In this way, the fingers may form a particular pattern or configuration across the surface of the radome. Certain patterns or shapes may vary the heat distribution across the surface of the radome. This may beneficially heat areas of the surface which require greater heating, i.e., areas where ice, snow, water build up is greater.

The fingers may be arranged extending from the loop to create hot spots on the surface, i.e., areas of the surface which have increased heating. Such hot spots may be beneficial if a thickness of the surface varying across the receiver coil. For example, the surface may require greater heating a plurality of areas due to increased thickness. The fingers may be arranged to created increased density of receiver coil heating in areas corresponding to these thicker areas of the surface.

The loop of the receiver coil may comprise one or more windings. The windings may also form the fingers. The loop may further comprise a winding around an outer perimeter of a plane defined by the receiver coil. The loop may further comprise a winding around the outer perimeter in the plane.

The receiver coil may comprise a resistive foil.

The resistive foil may be formed by a lithography process.

The resistive foil may form a closed loop.

The resistive foil may comprise a serpentine shape.

The resistive foil may comprise a loop with inner fingers. The fingers may also be evenly spaced in a plane formed by the loop. Each finger may comprise a pair of parallel trace segments. A spacing between the pair of parallel trace segments in a plane formed by the loop may define a finger width. Each trace segment of the parallel trace segments has a trace thickness; and the finger width may be at least the trace thickness. The finger width may be less than a spacing between fingers in a plane formed by the loop.

One or more fingers may extend in a first direction within a plane formed by the loop. The first direction may be perpendicular to a longitudinal side of the resistive foil. One or more fingers extend in a second direction within the plane formed by the loop. The second direction may be opposite to the first direction. Each finger extending in the first direction may be adjacent to at least one finger extending in the second direction.

The fingers may extend from a first longitudinal side of the resistive foil to a second longitudinal side of the resistive foil, the second longitudinal side being opposite to the first longitudinal side.

The outer portions of the loop may be wider than the fingers.

The loop can form a trapezoidal shape or a rectangular shape.

The resistive foil may be embedded in the surface of the radome, or on the surface of the radome.

According to another aspect there is provided a method of heating a surface of a radome. The method may include: transferring power via magnetic field coupling from a transmitter coil of a transmitter of a wireless power transfer system to a receiver coil for heating a surface of a radome.

The receiver coil may be positioned on the surface, or may be embedded within the surface. The receiver coil may be positioned on the surface of the radome such that transmitter coil is proximate the receiver coil, or such that the radome is between the transmitter coil and the receiver coil.

The method may further include: positioning the receiver coil on the surface of the radome. The positioning may occur prior to transferring power via magnetic field coupling. Positioning may include affixing the receiver coil to the surface. The receiver coil may be affixed via an adhesive, nails, screws, or any suitable fastening means. The receiver coil may be positioned on the surface of the radome such that transmitter coil is proximate the receiver coil, or such that the radome is between the transmitter coil and the receiver coil.

The method may further include: embedding the receiver coil within the radome. Embedding the receiver coil may comprise embedding the receiver coil within the surface such that the thickness of the surface is the same following the embedding.

The method may further include: positioning a sensor within the transmitter coil. The sensor is enclosed by the transmitter coil. The described radome may further comprises a detector, detection module or sensor positioned within the transmitter coil. The transmitter coil may circumscribe or enclose the sensor. The sensor may be positioned within the area or volume defined by the transmitter coil. The sensor may be adapted a sensor signal such as a radar signal, Lidar signal, or similar. The sensor may be for detecting objects proximate the surface of the radome.

The surface may be part of a vehicle such a vehicle bumper, hood, tailgate, trunk, sidewall, body panel, etc. The surface may be curved, i.e., concave, convex, spherical, etc.

The method may further include: emitting a signal from the sensor positioned within the transmitter coil. The signal may pass through the surface of the radome. The signal may be for detecting objects proximate the surface. The objects may be proximate a side of the surface which is opposite the receiver coil.

The receiver coil may be as described above. In other words, the receiver coil may comprise a loop having fingers extending therefrom. The loop and fingers may be in a single plane. The fingers may have associated fingers width and/or fingers spacing. All of aspects of the receiver coil described above may equally apply to the described methods.

According to another aspect there is provided a heating element for heating a surface of a radome, the heating element comprising a receiver coil of a receiver of a wireless power transfer system, the receiver coil for extracting power from a magnetic field generated by a transmitter coil of a transmitter of the wireless power system, the receiver coil comprising a closed loop having a plurality of fingers.

The receiver coil may be positioned on the surface of the radome, or may be embedded within the radome. As such, the transmitter coil may transfer power via magnetic field coupling through the surface of the radome to the receiver coil. The transmitter coil may transfer power to the receiver coil through another medium proximate the surface such as air or liquid. The transferred power may heat the receiver coil which may heat the surface of the radome. The receiver coil may be positioned on the surface of the radome such that the radome is between the receiver coil and the transmitter coil, or such that only a medium is between the transmitter and receiver coils, such as air or water. The material of the surface of the radome may be selected such that the generated magnetic field may pass through the radome to transfer power to the receiver coil.

The receiver coil may be as described above. In other words, the receiver coil may comprise a loop having fingers extending therefrom. The loop and fingers may be in a single plane. The fingers may have associated fingers width and/or fingers spacing. All of aspects of the receiver coil described above may equally apply to the described heating element.

While the above described aspects relate to heating a radome, one of skill in the art will appreciate the receiver coil may be used for heating a variety of other surfaces. For example, the receiver coil may be used to heat windscreens; cases; or housings for tools, appliances, or vehicles, including the front portion of a vehicle; reflective surfaces such as vehicle side-view/wing or rear-view mirrors; or satellite dishes, etc.

The radome may comprise multiple receiver coils, or only a single receiver coil. The multiple receiver coils may have identical configurations. Each receiver coil may be powered by a single transmitter coil, or each receiver coil may be powered by associated individual transmitter coils.

It should be understood that any features described in relation to one aspect, example or embodiment may also be used in relation to any other aspect, example or embodiment of the present disclosure. Other advantages of the present disclosure may become apparent to a person skilled in the art from the detailed description in association with the following drawings.

### BRIEF DESCRIPTION OF THE DRAWINGS

Embodiments will now be described more fully with reference to the accompanying drawings in which:

FIG. 1 is a block diagram of a wireless power transfer system;

FIG. 2 is a block diagram of a wireless power transfer system according to an aspect of the disclosure;

FIG. 3 is a perspective view of a radome according to an aspect of the disclosure;

FIGS. 4a and 4b are magnetic field plots of a transmitter coil of the system of FIG. 2;

FIGS. 5a and 5b are plan views of a receiver coil of the system of FIG. 2;

FIG. 6 is an enlarged plan view of a portion of a finger of the receiver coil of the system of FIG. 2;

FIG. 7 is a plot of conductivity versus resistance of the system of FIG. 2;

FIGS. 8a-8c are other arrangements of a receiver coil of the system of FIG. 2;

FIGS. 9a and 9b are plan view of receiver coils of the system of FIG. 2 in accordance with at least some embodiments;

FIG. 9c is a plot of conductivity versus resistance of the receiver coils of FIGS. 9a and 9b;

FIG. 10a is a plan view of another receiver coil of the system of FIG. 2;

FIG. 10b is a plot of conductivity versus resistance of the receiver coil of FIG. 10a;

FIG. 10c is a plan view of another receiver coil of the system of FIG. 2;

FIG. 11 is a plan view of another receiver coil of the system of FIG. 2;

FIG. 12 is a plan view of another receiver coil of the system of FIG. 2; and

FIG. 13 is a plan view of another receiver coil of the system of FIG. 2.

### DETAILED DESCRIPTION

The foregoing summary, as well as the following detailed description of certain examples will be better understood when read in conjunction with the appended drawings. As used herein, an element or feature introduced in the singular and preceded by the word “a” or “an” should be understood as not necessarily excluding the plural of the elements or features. Further, references to “one example” or “one embodiment” are not intended to be interpreted as excluding the existence of additional examples or embodiments that also incorporate the described elements or features. Moreover, unless explicitly stated to the contrary, examples or embodiments “comprising” or “having” or “including” an element or feature or a plurality of elements or features having a particular property may include additional elements or features not having that property. Also, it will be appreciated that the terms “comprises”, “has”, “includes” means “including but not limited to” and the terms “comprising”, “having” and “including” have equivalent meanings. It will also be appreciated that like reference characters will be used to refer to like elements throughout the description and drawings.

As used herein, the terms “adapted” and “configured” mean that the element, component, or other subject matter is designed and/or intended to perform a given function. Thus, the use of the terms “adapted” and “configured” should not be construed to mean that a given element, component, or other subject matter is simply “capable of” performing a given function but that the element, component, and/or other subject matter is specifically selected, created, implemented, utilized, and/or designed for the purpose of performing the function. It is also within the scope of the subject application that elements, components, and/or other subject matter that is described as being adapted to perform a particular function may additionally or alternatively be described as being configured to perform that function, and vice versa. Similarly, subject matter that is described as being configured to perform a particular function may additionally or alternatively be described as being operative to perform that function.

It will be understood that when an element is referred to as being “on,” “attached” to, “connected” to, “coupled” with, “contacting,” etc., another element, it can be directly on, attached to, connected to, coupled with or contacting the other element or intervening elements may also be present.

It should be understood that use of the word “exemplary”, unless otherwise stated, means ‘by way of example’ or ‘one example’, rather than meaning a preferred or optimal design or implementation.

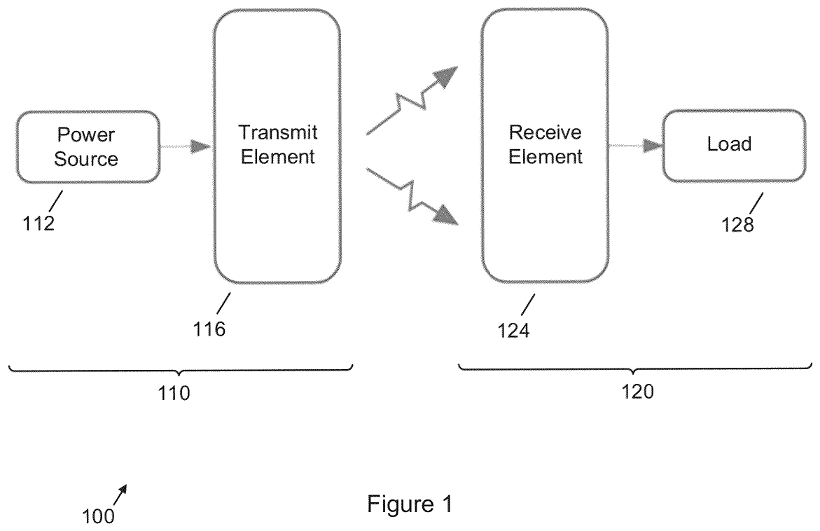

Turning now to FIG. 1, a wireless power transfer system generally identified by reference numeral 100 is shown. The wireless power transfer system 100 comprises a transmitter 110 comprising a power source 112 electrically connected to a transmitter element 116, and a receiver 120 comprising a receiver element 124 electrically connected to a load 128. Power is transferred from the power source 112 to the transmitter element 116. The power is then transferred from the transmitter element 116 to the receiver element 124 via resonant or non-resonant electric or magnetic field coupling. The power is then transferred from the receiver element 124 to the load 128. Exemplary wireless power transfer systems 100 include a high frequency inductive wireless power transfer system as described in applicant's U.S. Provisional Application No. 62/899,165, or a resonant capacitively coupled wireless power transfer system as described in applicant's U.S. Pat. No. 9,653,948B2, the relevant portions of which are incorporated herein.

In the wireless power transfer system 100, power is transferred from the transmitter element 116 to the receiver element 124. Exemplary wireless power transfer systems 100 include a high frequency inductive wireless power transfer system as described in U.S. patent application Ser. No. 17/018,328, the relevant portions of which are incorporated herein.

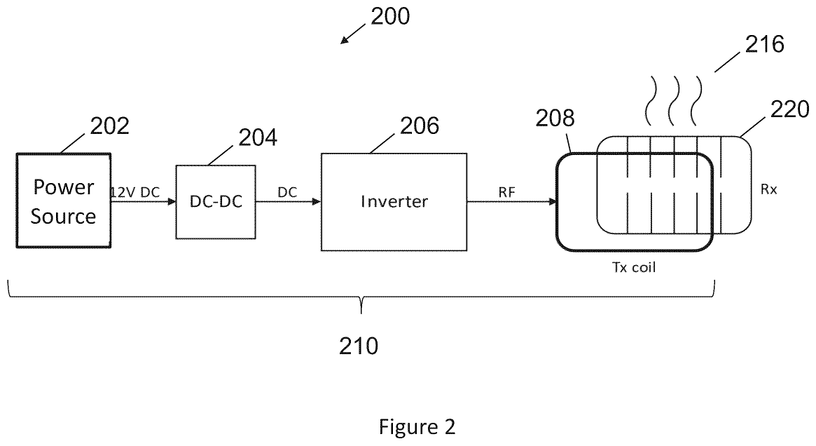

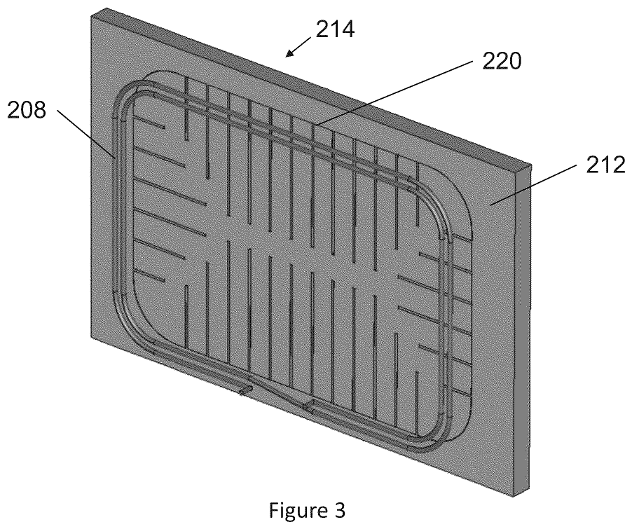

Turning now to FIG. 2, another arrangement of a wireless power transfer system 200 is illustrated. In this arrangement, the system 200 is incorporated into a radome as shown in FIG. 3 and as will be described. Generally, power is transferred from a transmitter coil 208 of a transmitter 210 to a receiver coil 220 via magnetic field coupling. The extracted power heats the receiver coil 220 to heat a surface 212 of the radome 214 to melt or remove snow, ice or water on the surface. The heat emitted by the receiver coil 220 is highlighted by reference symbol 216 in FIG. 2. This ensures a sensor signal emitted by a sensor positioned within the transmitter coil 208 is not inhibited by snow, ice, or water thereby improving sensor performance. Additionally no wires, cabling or other connections are necessary between the receiver coil 210 and the transmitter coil 208. A sensor positioned within the transmitter coil 208 may have an associated range of motion, such as a rotating radar dish. Such electrical connection equipment could inhibit the movement and therefore the use of the sensor. Further, the additional space required for the electrical connection equipment may take up space which could otherwise be used by the sensor. As such, the sensor may be smaller to accommodate the equipment, and therefore have reduced range and/or sensitivity. Alternatively, the overall form factor may be increased which may not be suitable for some applications.

The wireless power transfer system 200 comprises a transmitter 210 comprising a transmitter coil 208 among other elements. The system 200 further comprises a receiver coil 220. In contrast with the described system 100, the receiver coil 220 is the only element of the receiver. In other words, no DC/DC converter, rectifier or load (beyond the receiver coil 220 itself) are present as part of the receiver. The wirelessly transferred power is simply used to heat the receiver coil 220. As such, the receiver coil 220 generally forms a heating element for heating a surface of the radome.

In the illustrated arrangement, the transmitter 210 further comprises a power source 202 which outputs a DC power signal, e.g., a 12 V DC signal, a DC/DC converter 204 which converts the power signal to the required voltage, and an inverter 206 which inverts the DC power signal to AC. One of skill in the art will appreciate that the DC/DC converter 204 may be omitted from the transmitter 210.

While not illustrated in FIG. 2, the transmitter 210 may further comprise booster and/or shield coils such as those described in applicant's own U.S. patent application Ser. No. 17/193,539, the relevant portions of which are incorporated herein by reference.

During operation, the power source or supply 202 outputs a DC power signal. In the illustrated arrangement, the DC power signal has a voltage of 12 V. The DC/DC converter 204 converts the power signal to the required voltage range. The inverter 206 then inverts the power signal to AC. The AC signal is applied to the transmitter coil 208 to generate a magnetic field.

The receiver coil 220 positioned proximate the transmitter coil 208 extracts power from the generated magnetic field. The extracted power heats the receiver coil 220 to heat a surface on which the receiver coil is positioned as shown in FIG. 3. Any snow, ice, or water may be at least partially removed from an opposite side of the surface by the heat generated by the receiver coil 220. This may ensure that a sensor signal output by a sensor positioned within the transmitter coil 208 is not inhibited or otherwise impacted by the snow, ice, or water on the surface. This may improve the range and/or sensitivity of the sensor.

As shown in FIG. 3, the receiver coil 220 is positioned on surface 212 of radome 214. The transmitter coil 208 is proximate the receiver coil 220 such that electrical power is transferred through the medium (air) between the coils 208, 220. The receiver coil 220 which extract the power from the magnetic field generated by the transmitter coil 208 heats up which thus heats the surface 212. The side of the surface 212 which is opposite the receiver in the axial plane (not shown) is heated and ice, water or snow on this side of the surface 212 is at least partially removed.

While the receiver coil 220 is shown as being proximate the transmitter coil 208 with only air between them in the axial plane, the receiver coil 220 may be positioned on the opposite side of the radome 214. In this arrangement, the radome 214 itself is between the coils 208, 220 and the generated magnetic field passes through the radome 214 to heat the receiver coil 220. In another arrangement, the receiver coil 220 is embedded within the radome 214 itself such that the generated magnetic field passes through a portion of the radome 214 to heat the receiver coil 220 and the surface 212.

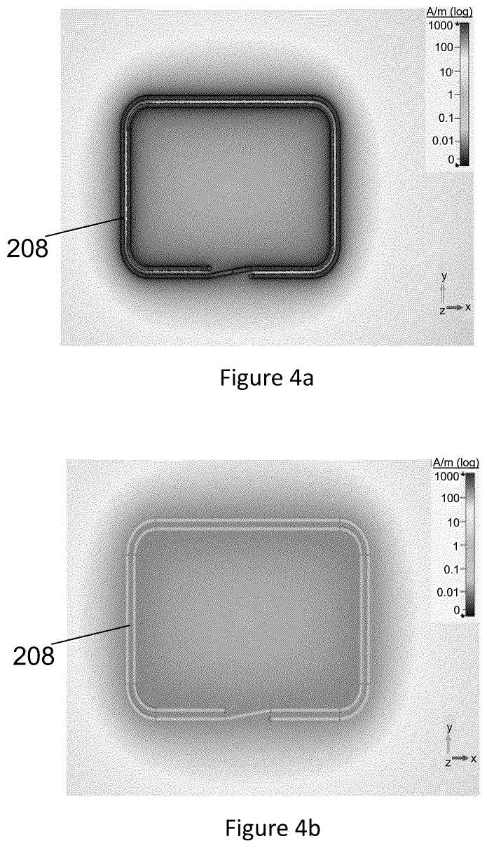

Turning now to FIGS. 4a and 4b, magnetic field plots of the transmitter coil 208 are illustrated. FIG. 4a is a plot of the magnetic field intensity directly proximate the transmitter coil 208, while FIG. 4b is a plot of the magnetic field intensity at a separation distance of 10 mm. The receiver coil 220 is positioned at a separation distance of approximately 10 mm.

As shown in these drawings, in this arrangement the transmitter coil 208 is formed of a single closed loop which forms multiple windings. In the illustrated arrangement, the transmitter coil 208 forms two windings although more or less may be present. As shown in both drawings, the magnetic field intensity is highest within the area defined by the windings and directly adjacent the outer perimeter of the windings.

The magnetic field intensity of the field generated by the transmitter coil 208 may impact the power transfer efficiency of the system 200. The power transfer efficiency is the ratio of power extracted by the receiver coil 220 to the power input to the transmitter coil 208.

As the receiver coil 220 is heating a surface of the radome, the heating efficiency is also relevant to the efficiency of the system 200. The heating efficiency is the percentage of radio frequency (RF) power input to the transmitter coil 208 that is dissipated as heat in the receiver coil 220.

Power loss may occur due to resistive losses in the transmitter coil 208. To maximize the heating efficiency, the receiver coil 220 should capture as much magnetic flux from the transmitter coil 208 as possible. The more flux captured by the receiver coil 220, the less current at the transmitter coil 208 is needed to produce a given amount of heat, hence the resistive loss in the transmitter coil 208 is minimized. Such maximising may be achieved by maximizing the resistance (R11) measured across the transmitter coil 208 at the operating frequency of the wireless power transfer system 200.

To maximise the power transfer efficiency, the receiver coil 220 may be placed as close as possible to the transmitter coil 208 while considering the magnetic field intensity. In the illustrated arrangement, the minimum separation distance is 10 mm. As shown in FIG. 4b, at this separation distance magnetic field intensity is maximised at the perimeter of the transmitter coil 208. However, the system may be configured for other separation distances, e.g., 5 mm, 6 mm, 7 mm, 8 mm, 9 mm, etc.

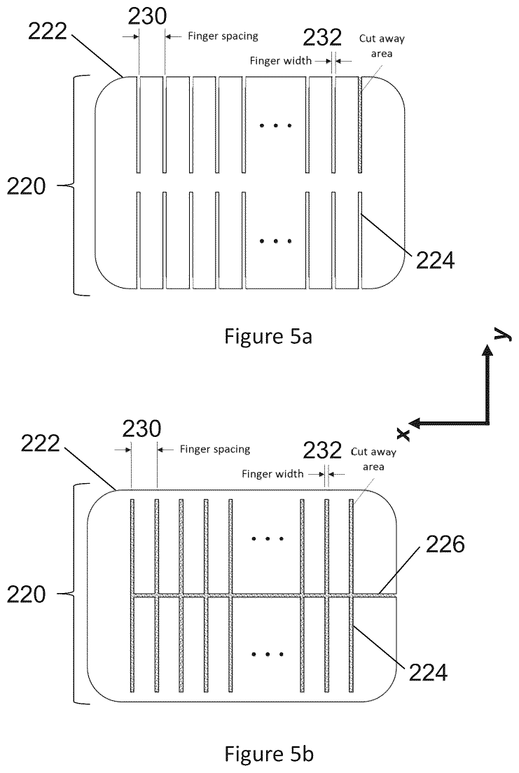

Turning now to FIG. 5a, the receiver coil 220 according to one arrangement is shown in more detail. In the illustrated arrangement, the receiver coil 220 comprises a loop 222, i.e., an outer loop, and a plurality of fingers 224 extending from the loop 222 towards a centre of the loop 222. In the illustrated arrangement, the loop 222 is generally rectangular in shape with rounded corners, although one of skill in the art will appreciate that the loop 222 may have other shapes. The loop 222 has a generally similar shape, footprint or trace to the transmitter coil 208. In other words, the outer dimensions of the loop 222 (length and width) are the same as the transmitter coil 208. The fingers 224 and the loop 222 form a serpentine path which defines the receiver coil 220.

The fingers 224 extend inward, i.e., toward a centre of the area defined by the loop 222. In the illustrated arrangement, the fingers 224 are parallel and are aligned with one side of the loop 222. Half of the fingers 224 extend from a longitudinal side of the loop 222 while the other half of the fingers 224 extend from the other longitudinal side of the loop 222. The fingers 224 are generally parallel with the short sides of the loop 222. As will be described, the fingers 224 may have other configurations.

The fingers 224 extending from one longitudinal side are equally spaced from each other in the longitudinal direction. The fingers 224 extending from the other longitudinal side are equally spaced from each other in the longitudinal direction. This spacing between adjacent fingers 224 is referred to as the finger spacing 230. The fingers spacing 230 is constant through each half of the fingers 224 such that heat is evenly distributed through a surface in contact with the receiver coil 220.

Each of the fingers 224 also has a corresponding finger width 232 which is the distance between adjacent sides, i.e., the adjacent wires which form the finger, of a single finger 224. As shown in FIG. 5a, the finger width 232 is constant through the length of finger 224. Conceptually the fingers 224 may be formed by cutting away area within the loop 222 of the receiver coil 220.

Turning to FIG. 5b, another arrangement of the receiver coil 220 is illustrated. In this arrangement, the outer loop 222 still defines an outer perimeter of the receiver coil 220, as with the receiver coil 220 of FIG. 5a; however, instead of fingers 224 extending directly from the outer loop 222, the fingers 224 extend from a central trunk 226. In this arrangement, the central trunk 226 extends in a longitudinal direction from one non-longitudinal side of outer loop 222. The trunk 226 is central to the outer loop 222 in that it generally bisects the non-longitudinal side of the outer loop 222.

The fingers 224 extend away from the central trunk 226 towards the outer loop 222 of the receiver coil 220. The fingers 224 are evenly distributed along the central trunk 226 with half extending in one direction and the other half in another, opposite, direction. The fingers 224 generally extend parallel to a short side of the outer loop 222.

Similar to the arrangement of FIG. 5a, the fingers 224 in FIG. 5b have associated finger spacing 230 between adjacent fingers 224, and each finger 224 has a finger width 232. In this arrangement, the finger spacing 230 and width 232 is constant between adjacent fingers 224 and sides of a single finger 224, respectively.

In the arrangement of FIG. 5b, a lesser portion of the outer loop 222 perimeter is lost to the extending fingers 224. Rather, only the central trunk 226 extends away from outer loop 222. As illustrated in FIG. 4b, the magnetic field intensity may be highest at the perimeter of the transmitter coil 208. As such, reducing the amount of lost perimeter of the outer loop 222 may maximize the magnetic flux captured by the receiver coil 220, thus improving the power transfer efficiency and accordingly the heating efficiency.

In both arrangements of the receiver coil illustrated in FIGS. 5a and 5b, the receiver coil 220 is symmetric in at least one axis. The coil 220 in FIG. 5a is symmetric in two axes. This may improve heat distribution on the surface of the radome, and/or reduce costs and time associated with manufacture of the coil 220.

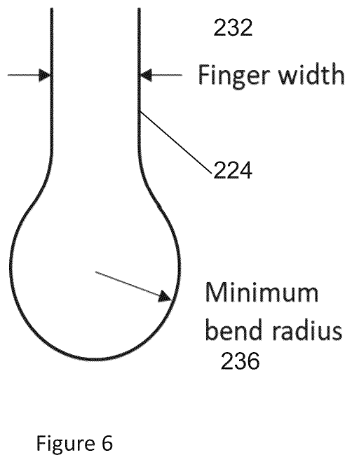

The particular design of the coils 208, 220 may be constrained by available manufacturing processes. For example, the receiver coil 220 may be embedded in a flat plastic sheet where it is laid to follow the described serpentine path comprising an outer loop 222 and fingers 224 extending therefrom. The precision of this embedding may be limited such that there is a minimum achievable bend radius 236, and a minimum achievable finger width 234 between arms or parallel wires of each finger 224. Such minimums are illustrated in FIG. 6 which depicts a portion of a single finger 224. As one of the finger's 224 arms extends in a direction, the loop formed to connect to arm of the finger 224 has an associated bend radius 236. The bend radius 236 may thus give the finger 224 a teardrop shape where the diameter (twice the bend radius 236) is larger than the finger width 232. This may be simply due to tolerances associated with manufacturing the finger 224.

As an alternative construction, the receiver coil 220 and/or the transmitter coil 208 may be manufactured via additive manufacturing such as for example 3D printing. Such additive manufacturing may not result in the same teardrop shape. That is to the diameter of the finger 224 may be equal to the finger width 232.

While not shown in FIGS. 5a, 5b and 6, the outer loop 222 and fingers 224 may be formed by multiple windings similar to the transmitter coil 208 illustrated in FIGS. 4a and 4b.

In the illustrated arrangement, the receiver coil 220 and/or transmitter coil 208 is constructed from nichrome heater wire, although one of skill in the art will appreciate other types of wire material may be used. For example, the receiver coil 220 and/or transmitter coil 208 may be constructed from silver wire.

While certain shapes of the coils 208, 220 have been illustrated, one of skill in the art will appreciate that other shapes may be used. For example, the coils 208, 220 may be triangular, circular, oval, square, trapezoidal, or any other suitable depending on the surface of the radome and the requirements of the sensor.

For a given receiver coil 220 shape, the heating efficiency may be dependent on the resistance of the receiver coil 220. If the resistance of the receiver coil 220 is too high, a current in the receiver coil 220 may be relatively low so little heat is generated to heat the surface of the radome. If the resistance is too low, a current in the receiver coil 220 may be higher, but little heat is dissipated. Thus, it is important to optimize the resistance for a receiver coil 220 design.

The resistance of the particular receiver coil 220 may be altered by changing a diameter and wire type of the receiver coil 220. Wires sizes may vary from 20 AWG (0.8 mm diameter) to 38 AWG (0.1 mm diameter), which are commonly available nichrome wire. Other wire sizes may be possible.

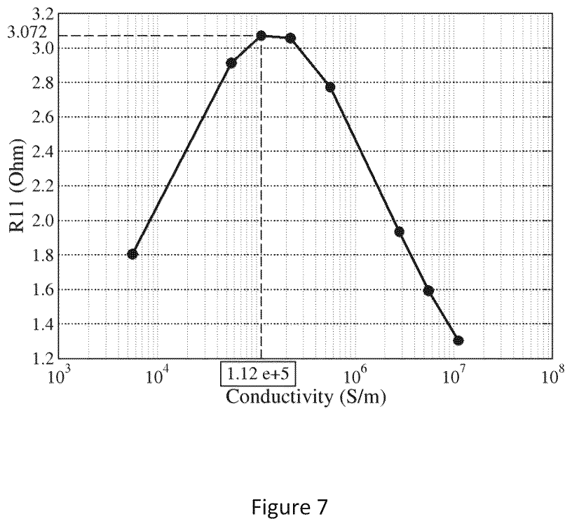

FIG. 7 is a plot of conductivity of a loop 222 of a given receiver coil 220 versus resistance across the transmitter coil 210. In particular, FIG. 7 is a plot of conductivity of the receiver coil 220 illustrated in FIG. 5a. The receiver coil 220 is a nichrome wire. FIG. 7 illustrates the effect of changing the diameter of the wire. For the purposes of this plot, the receiver coil 220 has a finger spacing 230 of 10 mm. As shown in FIG. 7, the conductivity at 5.6e+6 corresponds to the 0.3 mm nichrome wire, while the point at 0.9e+6 corresponds to the 0.1 mm wire. The optimal point occurs at an even lower conductivity of 1.2e+5, but this would require wire which is not readily available. Thus, for this receiver coil 220 a high resistance is suitable so the minimum wire size of 0.1 mm was selected.

The resistance of the receiver coil 220 may also be modified by changing the total length of the wire of the receiver coil 220. This can be accomplished by adding or removing fingers 224 from the coil 220. However, there is a trade-off between increasing resistance by adding fingers 224, and capturing the most flux of the magnetic field generated by the transmitter coil 208. This was determined by comparing loop designs with fingers spaced 10 mm apart and 7 mm apart. The benefits of adding length to the wire of the receiver coil 220 to provide higher wire resistance may be outweighed by the losses associated with reduced flux capture, so a loop 222 with 10 mm finger spacing may perform better despite having a lower resistance.

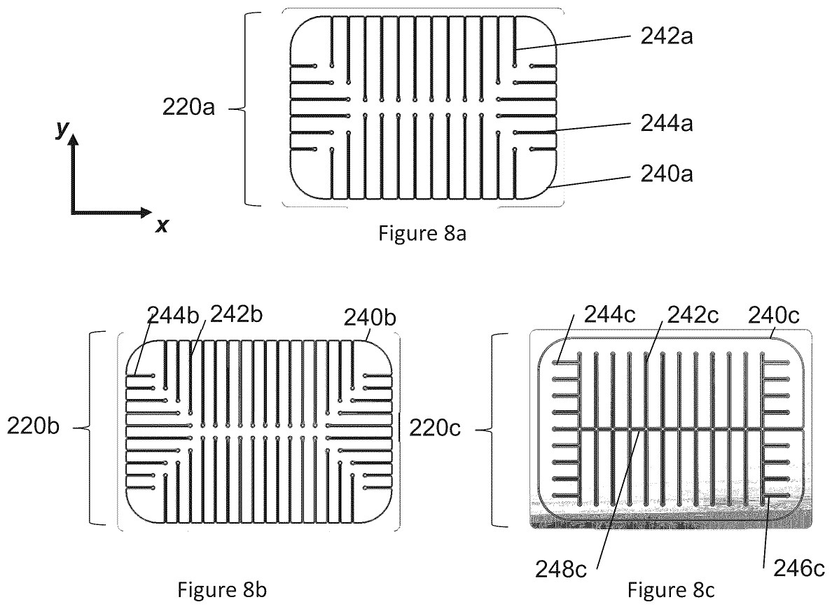

While particular receiver coil 220 arrangements have been described other configurations are possible. Several other arrangements of a receiver coil are illustrated in FIGS. 8a-8c. In FIG. 8a, a receiver coil 220a is illustrated which comprises two sets of fingers. A first set of fingers 242a and a second set of fingers 244a. The fingers 242a, 244b extend inward towards the centre of an outer loop 240a.

The receiver coil 220b illustrated in FIG. 8b similarly comprises two sets of fingers 242a, 242b extending inward from an outer loop 240b. However, in this arrangement the finger spacing between the sets of fingers is reduced such that more fingers are present within the area defined by the outer loop 240b. For example, the fingers 242a, 244a may have a finger spacing of 10 mm while the fingers spacing of fingers 242b, 244b may be 7 mm.

In both receiver coils 220a, 220b, the first set of fingers 242a, 242b extend in a first direction (e.g., the y direction or axes) and the second set of fingers 244a, 244b extend in a second direction (e.g., the x direction or axes). The second direction is perpendicular to the first direction.

The receiver coil 220c illustrated in FIG. 8c comprises an outer loop 240c similar to the receiver coil of FIG. 5b as the fingers extend within the inner area defined by the outer loop 240c. Specifically, a first set of fingers 242c extend in a first direction (e.g., the y direction or axes). The first set of fingers 242c extend from a central trunk 248c. The central trunk 248c extends in a longitudinal direction from one non-longitudinal side of outer loop 240c. The trunk 248c is central to the outer loop 240c in that it generally bisects the non-longitudinal side of the outer loop 240c.

A second set of fingers 244c extends from a first one of the fingers of the first set of fingers 242c. A third set of fingers 246c extends from a last one of the fingers of the first set of fingers 242c. The first finger may be a finger at longitudinal end of the first set of fingers 242c while the last finger is a finger at the other longitudinal end of the first set of fingers 242c. The first and last fingers are the fingers of the first set of fingers 242c which are the furthest apart from each other in the longitudinal direction (i.e., x direction or axes).

The described arrangements were tested to obtain their performance characteristics. Table 1 below outlines performance characteristics of the illustrated arrangements. In particular, table 1 illustrates the wire resistance of the receiver coil 220, the impedance seen by the transmitter 210, and the heating efficiency for a given arrangement (trial) of the wireless power transfer system 200. Each system operates at a resonant frequency of 27.12 MHz. Operating at this higher frequency may improve power transfer efficiency which may improve heating efficiency. Other possible resonant frequencies include 6.78 MHz, 13.56 MHz, and 40.68 MHz. Testing at 27.12 MHz showed improved resistance (R11) when compared with 13.56 MHz. Operating at 40.68 MHz may result in greater improvements to resistance (R11). However, there may be higher losses in the inverter 206 and greater overall losses when operating at 40.68 MHz. The receiver coil 220 and the transmitter coil 208 have a separation distance of 10 mm. The heating efficiency is calculated from the loaded and unloaded resistance. The receiver coil wire resistance is for the open loop, e.g., 222, of the respective receiver coil 220.

TABLE 1
Performance parameters of wireless power transfer system

| | | Wire | | |
|---|---|---|---|---|
| | Receiver coil | resistance | Transmitter | Heating |
| Trial | configuration | (Ω) | impedance | efficiency |
| 1 | Outer 10 mm spacing, | 51.6 | 4.48 − j4.9 | 75% |
| | 0.3 mm wire, 100% infill | | | |
| 2 | Outer 10 mm spacing, | 51.2 | 4.85 − j6.7 | 77% |
| | 0.3 mm wire, 50% infill | | | |
| 3 | Inner 10 mm spacing, | 54.8 | 5.25 − j1.0 | 79% |
| | 0.3 mm wire | | | |
| 4 | Outer 10 mm spacing, | 309.6 | 8.17 + j4.4 | 86% |
| | 0.1 mm wire | | | |
| 5 | Outer 7 mm spacing, 0.1 | 420.4 | 6.14 + j7.6 | 82% |
| | mm wire | | | |
| 6 | No Rx loop (unloaded) | — | 1.10 + j11.8 | — |

Trials 1 and 2 compare the effect of the plastic density on the loop performance. Whereas plastics typically exhibit greater tangent loss than air, the lower-density plastic had higher efficiency. In trial 1 the receiver coil 220 is formed with 100% plastic infill, i.e., plastic occupies 100% of the cut away area of the coil 220. In trial 2 the receiver coil is formed with 50% plastic infill, i.e., plastic occupies 50% of the cut away area of the coil 220. Additionally, plastic covers the entirety of the receiver coils 220 in trials 1 and 2. Finger spacing in both trials 1 and 2 is 10 mm. As shown in Table 1, lower density plastic improves heating efficiency. Trials 1 and 2 correspond with the arrangement illustrated in FIG. 8a.

Trial 3 corresponds with the arrangement illustrated in FIG. 8c. The finger spacing between adjacent fingers in the first, second and third sets of fingers 242c, 244c, 246c is uniformly 10 mm. The receiver coil 220 has a wire thickness of 0.3 mm. Trial 4 corresponds with the arrangement illustrated in FIG. 8a. The fingers spacing is also 10 mm; however, in this arrangement the receiver coil 220 has a wire thickness of 0.1 mm. Trial 5 corresponds with the arrangement illustrated in FIG. 8b. The fingers spacing is 7 mm, and the receiver coil 220 has a wire thickness of 0.1 mm. Similar to trial 1, trials 3-5 use 100% plastic.

Compared to trial 1, trial 4 shows that the same form with 0.1 mm wire performs better. This agrees with the simulated optimal loop resistance illustrated in FIG. 7. However, trial 5 shows that the loop with more fingers and thus higher resistance performs worse due to its reduced flux capture.

Finally, trial 3 shows that the inner loop design, which captures the most flux near the perimeter of the loop, outperforms the outer loop design of trial 1. The inner loop design with 0.1 mm wire is expected to have the best performance.

As mentioned above, the receiver coil 220 may be manufactured via additive manufacturing. For example, a lithographic process with ink can be used to produce a receiver coil 220. The lithographic process allows for greater flexibility in the design of the loop 222, and in particular, flexibility in the bend radius 236 of each finger 224. That is, the end of each finger 224 may not be a teardrop shape.

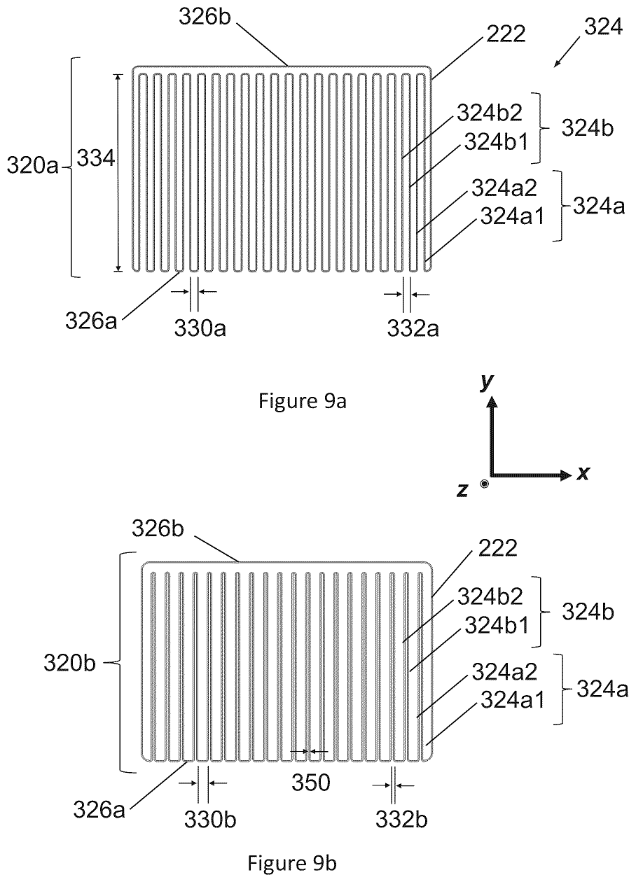

Turning now to FIGS. 9a and 9b, receiver coils 320a and 320b according to some arrangements are shown. In the illustrated arrangement of FIG. 9a, the receiver coil 320a includes a set of fingers 324 formed of a resistive foil material. Although receiver coil 320a is shown with 20 fingers, other embodiments can include fewer or more fingers. The set of fingers 324 extend inward from a first longitudinal side 326a of the loop 222 towards an opposite longitudinal side 326b of the loop 222. That is, the set of fingers 324 extend in a direction perpendicular to the first longitudinal side 326a. Each finger 324 has a finger length 334. In the illustrated arrangement of FIG. 9a, the fingers 324 have equal finger lengths 334. In other embodiments, at least one finger can have a different finger length 334 than one or more fingers.

In some embodiments, the structure of the receiver coil 320a can be arranged to minimize interference with the sensor signal (e.g., radar signal). For example, the fingers 324 extending in a direction (i.e., vertical or y direction) perpendicular to the longitudinal side can allow a vertically polarized sensor signal to pass through the receiver coil 320a, thus minimizing interference. Conversely, if the sensor signal is rotated by 90 degrees, fingers extending in a direction (i.e., horizontal or x direction) parallel to the longitudinal side can minimize interference. In some embodiments, the structure of the receiver coil 320a can be designed based on other factors unrelated to signal interference, such as heat distribution.

As shown in FIG. 9a, the spacing between fingers 324a, 324b in the plane formed by the loop 222 defines a finger spacing 330a. In the illustrated arrangement of FIG. 9a, the fingers 324a, 324b are evenly distributed along the first longitudinal side 326a. That is, the finger spacing 330a is even. In other embodiments, at least one finger spacing 330a can be different from one or more other finger spacings 330a within the loop 222.

As shown, each finger 324a, 324b includes a pair of parallel trace segments. For example, a first finger 324a is defined by trace segments 324a1, 324a2 and a second finger 324b is defined by trace segments 324b1, 324b2. The spacing between trace segments 324a1, 324a2 in the plane formed by the loop 222 defines a finger width 332a. In the illustrated arrangement of FIG. 9a, the finger width 332a of finger 324a is the same as, or similar to, the finger width 332a of finger 324b. In other embodiments, the finger width 332a can be different for one or more fingers 324a, 324b.

Further, in the illustrated arrangement of FIG. 9a, the finger width 332a is the same as the finger spacing 330a. In contrast, the finger width 332b of the receiver coil 320b of FIG. 9b is less than the finger spacing 330b. That is, the spacing between trace segments 324a1, 324a2 of the same finger 324a is smaller than the spacing between fingers 324a, 324b, that is, the spacing between trace segment 324a2 of finger 324a and trace segment 324b1 of finger 324b. The finger width 332b being less than finger spacing 330b can maximize the flux captured by the receiver coil 320b from the transmitter coil compared to the flux captured by the receiver coil 320a with the finger width 332a being the same as finger spacing 330a. Maximizing the flux captured by the receiver coil 320b can improve the heating efficiency of the receiver coil 320a. In some embodiments, the finger width 332a, 332b is at least the thickness of the trace segment 324a1, 324a2, 324b1, and 324b2 to reduce the likelihood of trace ink of adjacent traces bleeding into one another.

With resistivity foils 320a, 320b, the main heat source to warm the radome is resistance to current flow within the trace segments of the loop 222. The resistivity of the receiver coil 320a, 320b can be optimised to improve heating efficiency. In particular, the resistive foil used to form receiver coil 320a, 320b can be designed to achieve a particular desired resistivity. For example, different trace inks having a specific material conductivity can be used. As well, the dimensions of the receiver coil 320a, 320b can be varied, including the finger spacing 330a, 330b, the finger width 332a, 332b, and the cross-section of the trace segments, such as the width 350 and thickness (in a z direction).

An optimal loop resistance for a receiver coil 320a, 320b having a given conductivity and dimensions can be determined from Equation (1) below:

$${R}_{loop} = \frac{1}{σ} \times \frac{l}{A}$$

where Rₗₒₒₚ is the loop resistance;
   σ is the material conductivity;
   l is the total length of the loop; and
   A is the cross-sectional area of the trace segment.

Turning now to FIG. 9c, shown therein is a plot of conductivity of loop 222 versus resistance across the transmitter coil 210 at 27.12 MHz. In particular, the dotted line shown in FIG. 9c is a plot of the conductivity of the receiver coil 320a (i.e., equally spaced traces design) illustrated in FIG. 9a and the solid line is a plot of the conductivity of the receiver coil 320b (i.e., paired traces design) illustrated in FIG. 9b. As shown, the receiver coil 320b has a higher resistance than the receiver coil 320b, thus, it allows for more heating. Further, the optimal material conductivity is approximately 1×10⁵ S/m.

As mentioned earlier, the loop 222 has a generally similar shape, footprint or trace to the transmitter coil 208. In other words, the outer dimensions of the loop 222 (length and width) are the same as the transmitter coil 208. In the embodiment shown in FIG. 9b, the outer dimensions of the loop 222 can be 160 mm by 110 mm, the loop 222 includes 20 fingers, a finger spacing of 6.5 mm, and each finger has a finger length of approximately 100 mm. Thus, the total length of the loop 222 is approximately 4.5 m. With these dimensions and a sheet resistivity, or ink chemistry of 1 Ω/sq, a width and a thickness for the trace segments of receiver coil 320b of 0.8 mm and 0.5 mm respectively, can be optimal.

Referring back to Equation (1), the optimal loop resistance for the receiver coil 320b can be:

$${R}_{320 b} = \frac{1}{1 {0}^{5}} \times \frac{4.5}{4 \times 1 {0}^{- 7}} = 112 Ω$$

Alternatively, the optimal linear resistance is 25 Ω/m.

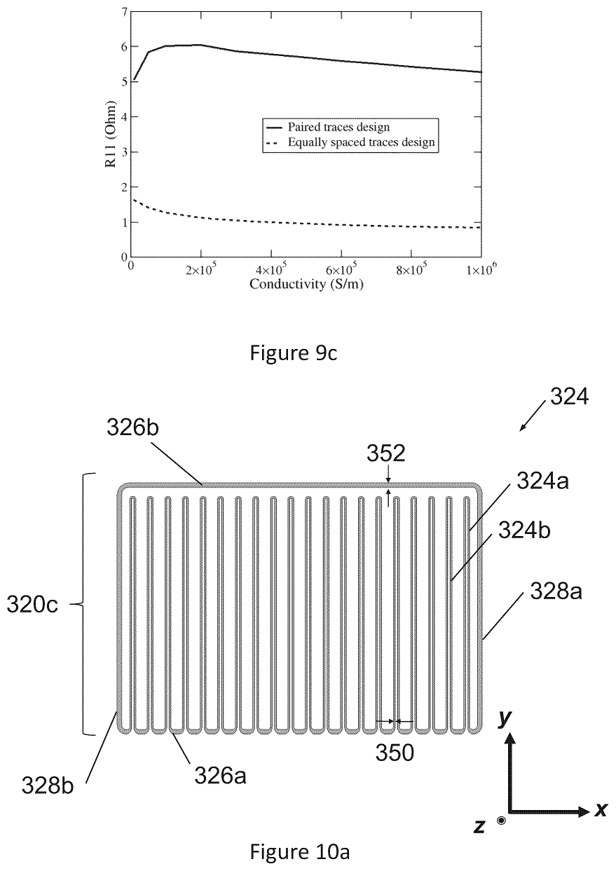

Turning now to FIG. 10a, another example arrangement of a receiver coil 320c is shown. Receiver coil 320c is also formed of a resistive foil and has similar dimensions to the dimensions of receiver coil 320b. However, to further concentrate heat dissipation within the loop 222, that is, in the set of fingers 324, the outer portions of the loop 222, such as longitudinal sides 326a, 326b, and lateral sides 328a, 328b, can have an increased width 352. For example, the width 352 of the longitudinal sides 326a, 326b and the lateral sides 328a, 328b can be approximately 2 mm wide while the width 350 of the trace segments of the fingers can be 0.8 mm. Increased width reduces the resistance, which in turn, leads to less heat dissipation. Thus, increasing the resistance generally enhances energy dissipation. FIG. 10b shows a plot of the conductivity of loop 222 versus resistance across the transmitter coil 210 for receiver coil 320c.

Turning now to FIG. 10c, another example arrangement of a receiver coil 320d is shown. The receiver coil 320d is also formed of a resistive foil and offers a similar heating efficiency and transmitter coil current requirements as the receiver coil 320c of FIG. 10a. However, a narrower trace width 350 is preferred to maximize the clear area of the radome and thus minimize radar signal attenuation. As such, the width 350d of the trace segment of receiver coil 320d is less than the width 350 of the trace segment of receiver coil 320c. However, to achieve a similar cross-sectional area as the receiver coil 320c, the thickness of the trace segment (in the z direction) of receiver coil 320d is increased. That is, the thickness of the trace segment of receiver coil 320d is greater than the thickness of the trace segment of receiver coil 320c to achieve a similar cross-sectional area and resistance as that of receiver coil 320c. In general, to achieve a sufficiently low sheet resistivity, the width 350 of the trace segment can be decreased to a minimal width and the thickness of the trace segment can be increased to a maximum width.

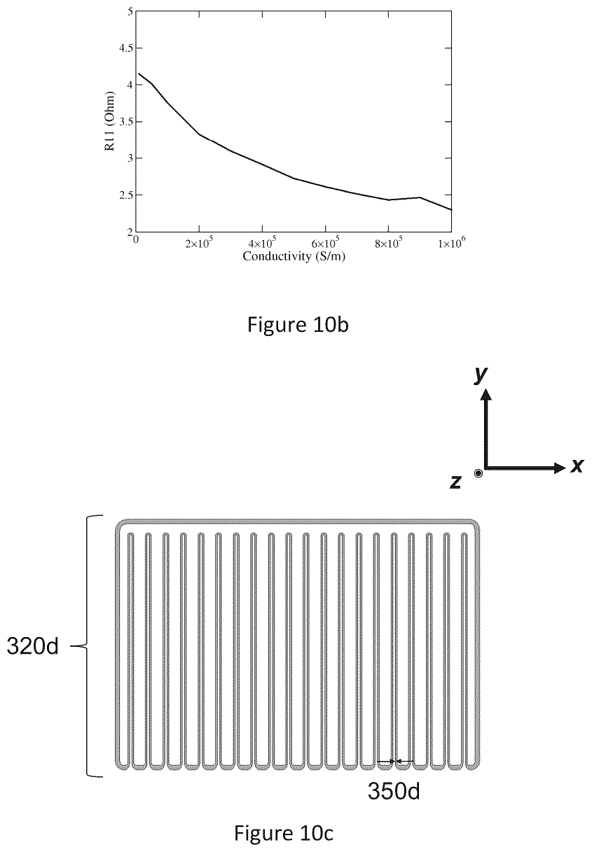

Turning now to FIG. 11, another example arrangement of a receiver coil 320e is shown. Similar to receiver coil 320b, the receiver coil 320e is formed of a resistive foil and includes 20 fingers. However, receiver coil 320e includes a first set of fingers 324 and a second set of fingers 344. The first set of fingers 324 extend inward from a first longitudinal side 326a of the loop 222 towards a second longitudinal side 326b of the loop 222 that is opposite to the first longitudinal side 326a. Meanwhile, the second set of fingers 344 extend inward from the second longitudinal side 326b towards the first longitudinal side 326a. As shown in FIG. 11, finger 344a extending in a first direction (i.e., from the second longitudinal side 326b toward the first longitudinal side 326a) is adjacent to finger 324a extending in a second direction (i.e., from the first longitudinal side 324a toward the second longitudinal side 326b). Further, finger 324a extending in the second direction is between fingers 344a and 344b, both extending in the first direction. That is, each finger is adjacent to fingers extending in the opposite direction. The arrangement of receiver coil 320e provides a more centered heating with fingers extending from both longitudinal sides compared the receiver coil 320b in which fingers extend from one longitudinal side.

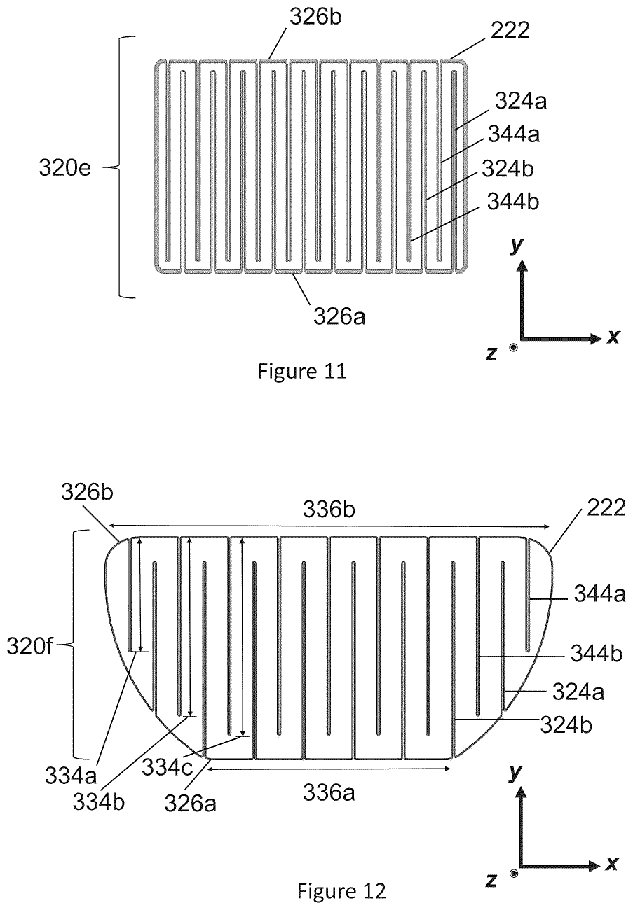

Turning now to FIG. 12, another example arrangement of a receiver coil 320f is shown. Similar to receiver coil 320e, the receiver coil 320f is formed of a resistive foil with two sets of fingers 324 and 344 that extend inward from opposite longitudinal sides of the loop 222. The first set of fingers 324 includes 8 fingers that extend inward from a first longitudinal side 326a of the loop 222 towards a second longitudinal side 326b of the loop 222 that is opposite to the first longitudinal side 326a. Meanwhile, the second set of fingers 344 includes 9 fingers that extend inward from the second longitudinal side 326b towards the first longitudinal side 326a. Again, each finger is adjacent to fingers extending in the opposite direction. In the illustrated arrangement, the loop 222 is generally trapezoidal in shape with rounded corners. That is, the longitudinal side 326a has a length 336a that is less than the length 336b of the opposite longitudinal side 326b. With the trapezoidal shaped loop 222, the finger length 334a, 334b, 334c can vary. The shape and dimensions of the loop 222 can be optimised to the space available for a particular application.

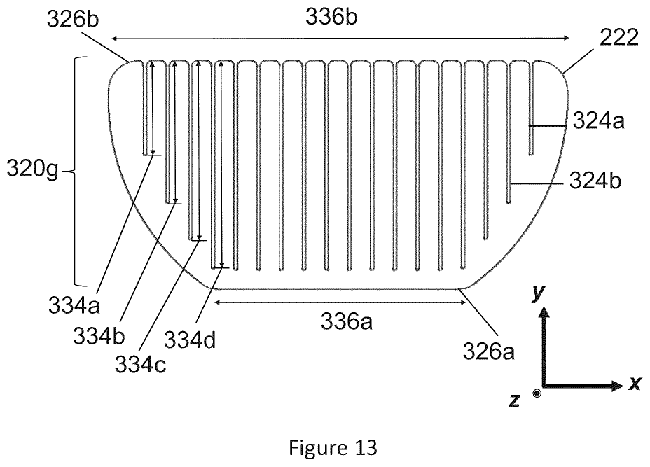

Turning now to FIG. 13, another example arrangement of a receiver coil 320g is shown. Similar to receiver coil 320f, the receiver coil 320g is formed of a resistive foil with a loop 222 that is generally trapezoidal in shape. That is, a longitudinal side 326a has a length 336a that is less than the length 336b of the opposite longitudinal side 326b. Similar to receiver coil 320d, receiver coil 320g includes 18 fingers that extend inward from longitudinal side 326b of the loop 222 towards longitudinal side 326a of the loop 222. Again, with the trapezoidal shaped loop 222, the finger length 334a, 334b, 334c, 334d can vary. The shape and dimensions of the loop 222 can be optimised to the space available for a particular application.

Although embodiments have been described above with reference to the figures, those of skill in the art will appreciate that variations and modifications may be made without departing from the scope thereof as defined by the appended claims.

1. A radome comprising:
a heating element for heating a surface of the radome, the heating element consisting of a receiver coil of a receiver of a wireless power transfer system, the receiver coil formed of a resistive foil; and
a transmitter coil of a transmitter of a wireless power transfer system, the transmitter coil for generating a magnetic field for transferring power to the receiver coil via magnetic field coupling.

2. (canceled)

3. The radome of claim 1, wherein the receiver coil forms a closed loop.

4. The radome of claim 1, wherein the resistive foil is formed by a lithography process.

5. (canceled)

6. The radome of claim 1, wherein the receiver coil comprises one or more of a serpentine shape or a loop with inner fingers.

7. The radome of claim 6, wherein the fingers are evenly spaced in a plane formed by the loop.

8. The radome of claim 6, wherein each finger comprises a pair of parallel trace segments, a spacing between the pair of parallel trace segments in a plane formed by the loop defines a finger width.

9. The radome of claim 8, wherein:
each trace segment of the parallel trace segments has a trace thickness; and
the finger width is at least the trace thickness.

10. The radome of claim 8, wherein the finger width is less than a spacing between fingers in a plane formed by the loop.

11. The radome of claim 6, wherein one or more fingers extend in a first direction within a plane formed by the loop.

12. The radome of claim 11, wherein the first direction is perpendicular to a longitudinal side of the resistive foil.

13. The radome of claim 11, wherein one or more fingers extend in a second direction within the plane formed by the loop, the second direction being opposite to the first direction.

14. The radome of claim 13, wherein each finger extending in the first direction is adjacent to at least one finger extending in the second direction.

15. The radome of claim 6, wherein the fingers extend from a first longitudinal side of the resistive foil to a second longitudinal side of the resistive foil, the second longitudinal side being opposite to the first longitudinal side.

16. The radome of claim 6, wherein outer portions of the loop are wider than the fingers.

17. The radome of claim 6, wherein the loop forms a trapezoidal shape or a rectangular shape.

18. (canceled)

19. A method of heating a surface of a radome, the method comprising:
transferring power via magnetic field coupling from a transmitter coil of a transmitter of a wireless power transfer system to a receiver coil for heating a surface of a radome.

20. (canceled)

21. (canceled)

22. The method of claim 19, further comprising:
affixing the receiver coil to the surface of the radome or embedding the receiver coil within the radome.

23. The method of claim 19, further comprising:
positioning a sensor within the transmitter coil.

24. The method of claim 23, further comprising:
emitting a signal from the sensor positioned within the transmitter coil, wherein the signal passes through the surface of the radome.

25. (canceled)

26. A heating element for heating a surface of a radome, the heating element comprising a receiver coil of a receiver of a wireless power transfer system, the receiver coil formed of a resistive foil, the receiver coil for extracting power from a magnetic field generated by a transmitter coil of a transmitter of the wireless power system, the receiver coil comprising a closed loop having a plurality of fingers.
